(19) United States
(12) Patent Application Publication
(10) Pub. No.: US 2022/0302571 A1
(43) Pub. Date: Sep. 22, 2022

(54) METHOD FOR MANUFACTURING A WAVEGUIDE DEVICE BY ADDITIVE MANUFACTURING AND ELECTRODEPOSITION, AND SEMI-FINISHED PRODUCT

(71) Applicant: SWISSto12 SA, Renens (VD) (CH)

(72) Inventor: Mathieu Billod, Présilly (FR)

(21) Appl. No.: 17/596,660

(22) PCT Filed: Jul. 9, 2020
(86) PCT No.: PCT/IB2020/056471

§ 371 Date: Dec. 16, 2021

(30) Foreign Application Priority Data
Jul. 11, 2019 (FR) FR1907839

(51) Int. Cl. H01P 11/00; B33Y 10/00; B33Y 80/00; C25F 3/26; C25D 1/00

(52) U.S. Cl. CPC H01P 11/002; B33Y 10/00; B33Y 80/00; C25F 3/26; C25D 1/00

(57) ABSTRACT

A method of manufacturing a waveguide device including the following steps: additive manufacturing of a core provided with an opening; additive manufacturing of at least a portion of an anode through the opening; immersion of the core in a metal ion bath; and electrodeposition of a conductive metal layer on the walls of the opening, by applying an electric current between the anode and a cathode.

### TECHNICAL FIELD

The present invention relates to a method for additive manufacturing of a waveguide device and to a waveguide manufactured according to this method.

### STATE OF THE ART

Radio frequency (RF) signals can propagate either in space or in waveguide devices. These waveguide devices are used to channel RF signals or to manipulate them in the spatial or frequency domain.

The present invention relates particularly to passive RF devices that allow propagation and manipulation of radio frequency signals without the use of active electronic components. Passive waveguide devices can be divided into three distinct categories:
Devices based on wave guidance inside hollow metal channels, commonly called waveguides.
Devices based on wave guidance inside dielectric substrates.
Devices based on wave guidance by means of surface waves on metal substrates such as PCBs, microstrips, etc.

The present invention relates particularly to the manufacture of waveguide devices according to the first category above, collectively referred to hereinafter as waveguide devices. Examples of such devices include waveguides per se, filters, antennas, polarizers, mode converters, etc. They can be used for signal routing, frequency filtering, signal separation or recombination, transmission or reception of signals into or from free space, etc.

Conventional waveguides consist of hollow devices, whose shape and proportions determine the propagation characteristics for a given wavelength of the electromagnetic signal. Conventional waveguides used for radio frequency signals have internal openings of rectangular or circular cross-section. They allow the propagation of electromagnetic modes corresponding to different electromagnetic field distributions along their section.

Apart from these examples of rectangular or circular waveguide openings, other opening shapes have been conceived or can be conceived within the scope of the invention which allow, for example, to maintain one or more electromagnetic mode(s) at a given signal frequency in order to transmit an electromagnetic signal, to separate it into several polarizations, to filter it, etc. The shape and surface of the section may furthermore vary along the main direction of the waveguide device.

Manufacturing waveguides with complex cross-sections is difficult and expensive. In order to remedy this, patent application U.S. 2012/0084968 proposes to produce waveguides by 3D printing. For this purpose, a non-conductive plastic core is printed by an additive method and then covered with a metal dip plating. The internal surfaces of the waveguide must indeed be electrically conductive to operate. The use of a non-conductive core allows on the one hand to reduce the weight and the cost of the device, and on the other hand to implement 3D printing methods adapted to polymers or ceramics and allowing to produce high precision parts with a low wall roughness. The parts described in this document have complex shapes and include on the one hand a channel for the wave propagation, and on the other hand fixing holes on a stand of the waveguide, in order to fix it to another element.

Various techniques can be used to deposit the metal coating on the inner and possibly outer surfaces of the core. However, the problem is complex due to the small size of the opening, the complex shapes that often need to be covered, and the need to control with great precision the dimensions of the opening and thus the thickness of the coating.

For this reason, chemical deposition methods, without electric current, are sometimes used. These methods involve immersing the part to be plated successively in one or more baths containing reagents that trigger chemical reactions resulting in the deposition of the chosen metallic material, for example copper, gold, silver, nickel, etc., on the surface to be coated. However, chemical deposition without electric current is relatively slow and the efficiency and dynamics of the deposition depend on many factors, including the concentration of reagents and metal ions in the various baths near the surfaces to be coated. These multiple parameters make the deposition difficult to control.

In order to improve the speed and control of the deposition, electrodeposition methods have also been implemented, based on the use of an electric current between a cathode on the wall to be coated and an anode immersed in a liquid filled with metal ions. As an example, Yiley Huang et al, in “Layer-by-Layer stereolithography of three-dimensional antennas”, presented at the “Antennas and propagation society symposium”, 2005, IEEE Washington, DC, Jul. 3-8, 2005, vol. 1A, page 276, ISBN: 978-0-7803-8883-3, describe a method of metal electrodeposition on a microwave component made by stereolithography.

Another electrodeposition method is described in FR2433838A1

In the case of a deposition coating, or even in the case of chemical deposition without the application of an electric current, the surface condition of the walls of the opening is often insufficient, so that these walls must be polished. Various methods have been proposed for this purpose. Electrodeposition by means of a current between an anode in the waveguide aperture and the waveguide walls is particularly efficient.

The anode used for electrodeposition or electropolishing is most often realized as an electrically conductive cable through the waveguide opening. The diameter of this cable must be relatively large in order to allow high currents to flow without excessive heating; the cable therefore necessarily has a certain rigidity. The introduction of such a cable into the waveguide opening is relatively easy in the case of a straight waveguide, but can be complex in the case of a curved waveguide, or when the opening is divided, especially in the case of a polarizer or a recombination element for example. It is indeed necessary to ensure that the anode does not touch the inner walls of the opening during deposition, in order to avoid a short circuit.

### BRIEF SUMMARY OF THE INVENTION

An aim of the present invention is to provide a method of manufacturing a waveguide device that is exempt from the above limitations.

Another aim of the invention is to provide a waveguide device manufactured according to this method that is exempt from the limitations of the above waveguide devices.

According to the invention, these aims are achieved in particular by means of a method for manufacturing a waveguide device comprising the following steps:
additive manufacturing of a core provided with an opening
additive manufacturing of at least one anode portion through said opening;
said anode is removed after electrodeposition or electropolishing.

This anode is intended, for example, for the electrodeposition of a conductive metal layer on the walls of the opening. In this case, the method comprises a step of immersing the core in a metal ion bath and then a step of electroplating the conductive metal layer on the walls of said opening by applying an electric current between said anode and a cathode.

Alternatively, or in addition, this anode can also be used for electropolishing the walls of the opening.

Manufacturing the anode by an additive manufacturing method allows avoiding the additional step of inserting a separately manufactured anode into an opening of the waveguide.

In a preferred embodiment, at least the portion of the anode that passes through the opening is made in one piece by additive manufacturing.

In a preferred embodiment, the anode is made in one piece by additive manufacturing.

The anode can be made at the same time as the core of the device.

The core is formed from an electrically conductive material, such as metal.

The core and the anode can be formed from the same metallic material and produced in a single additive manufacturing step. Thus, no additional equipment is required to manufacture the core.

In an embodiment, the core is formed from an insulating material and coated with a conductive layer serving as a cathode during electrodeposition and/or electropolishing. The anode is formed through the opening by additive manufacturing in an insulating material.

In an embodiment, the method may include a step of additively manufacturing detachable portions intended to hold said anode in the opening at least during manufacturing.

In an embodiment, these detachable portions bind the anode to a plurality of points on the sidewalls of the opening.

These detachable portions can be detached prior to the electroplating step, particularly in order to interrupt the galvanic connection between the anode and the opening.

The anode may be held in the opening by temporary holding means after detachment of said detachable portions and during electrodeposition.

In an embodiment, the detachable portions are electrically insulated from the anode and/or cathode, or form an electrical insulation between the anode and cathode, and are detached after said electroplating step. This embodiment avoids the need to temporarily hold the anode after removal of the detachable portions, but requires making the detachable portions, at least partially, of a different insulating material than the conductive anode, or alternatively bonding the detachable portions to electrically insulating portions of the waveguide.

The anode is preferably removed after the electrodeposition.

The invention also relates to a semi-finished product intended for the manufacture of a waveguide device, comprising:
a core with an opening;
an anode through said opening; and
detachable portions for temporarily holding the anode in the opening;
said core, said anode and said detachable portions all being additively manufactured.

In an alternative embodiment, the detachable portions advantageously include pre-cut areas, for example areas of lesser thickness or diameter, intended to be easily broken by manipulating the detachable portions with a hand, pliers, or a cutting instrument.

The invention also relates to a waveguide device obtained by the method of the invention and from the above semi-finished product.

By waveguide device is meant in the present application any device comprising a hollow channel delimited by conductive walls and intended for guiding RF electromagnetic waves in the channel, for example, for transmitting an electromagnetic signal at distance, filtering, receiving and transmitting in the ether (antennas), mode conversion, signal separation, signal recombination, etc.

Daigle Maxime et al, “Photoimageable Thick-Film MicroCoaxial Line for DC-to-Millimeter-Wave Broadband Applications,” IEEE TRANSACTIONS ON COMPONENTS, PACKAGING AND MANUFACTURING TECHNOLOGY, IEEE, USA, vol. 4, No. 1, Jan. 1, 2014 (Jan. 1, 2014), pages 117-122, XP011536225, ISSN: 2156-3950, DOi: 10.1109/TCPMT.2013.2265053 describes a method for the additive manufacturing of a waveguide having an internal conductor shown in FIG. 3 in particular. However, it is not suggested to use this internal conductor for an electrodeposition or electropolishing step, or to hold it by means of removable portions.

The invention relates in particular to devices capable of operating in the frequency bands L, S, C, X, Ku, K, Ka, Q, V, W, F, D or G.

The term “additive manufacturing” describes any method of manufacturing parts by adding material, according to computer data stored on a computer medium and defining a model of the part. In addition to stereolithography, the term also refers to other manufacturing methods such as liquid or powder curing or coagulation, including but not limited to binder jetting, DED (Direct Energy Deposition), EBFF (Electron beam freeform fabrication), FDM (fused deposition modeling), PFF (plastic freeforming), aerosol, BPM (ballistic particle manufacturing), powder bed, SLS (Selective Laser Sintering), ALM (additive Layer Manufacturing), polyjet, EBM (electron beam melting), photopolymerization, etc.

The method may include a step of surface treatment of the core to promote bonding of the conductive metal layer. The surface treatment may include an increase in surface roughness, and/or the deposition of an intermediate bonding layer.

### BRIEF DESCRIPTION OF THE FIGURES

Examples of embodiments of the invention are shown in the description illustrated by the appended figures in which:

FIG. 1 illustrates a perspective view of a semi-finished product having an uncoated core, an anode through the opening in the core, and cutout portions for holding the anode in the opening at least during manufacturing of the anode.

FIG. 2 shows a perspective view of a semi-finished product with an uncoated core, an anode through the opening in the core, after removal of the cutout portions.

FIG. 3 shows a perspective view of a waveguide device after deposition of a conductive layer on the walls of the opening, and before removal of the anode.

### EXAMPLE(S) OF EMBODIMENT OF THE INVENTION

The waveguide device 1 of the various described or claimed embodiments, for example the one of FIG. 3, comprises a core 3, for example a core made of metal (aluminum, titanium, or steel), or polymer, epoxy, ceramic, or organic material. The core is preferably made of an electrically conductive material.

The core 3 is manufactured by additive manufacturing, preferably by stereolithography, selective laser melting or selective laser sintering (SLS) to reduce surface roughness. The core material can be non-conductive or conductive. The wall thickness of the core is for example between 0.5 and 3 mm, preferably between 0.8 and 1.5 mm.

The shape of the core may be determined by a computer file stored in a computer data medium.

The core can also consist of several parts formed by 3D printing and assembled together before plating, for example by gluing or thermal fusion or mechanical assembly.

This core 3 delimits an internal opening 2 forming a channel for wave guidance. The core 3 therefore has an inner surface 7 and an outer surface 8, the inner surface 7 covering the walls of the opening 2 of rectangular cross-section.

The cross-section of the opening 2 may be rectangular, as shown in the Figures. However, the invention is not limited to waveguide devices with a circular cross-section and the invention may also be applicable to devices with any cross-section, including oval, elliptical, rectangular with rounded corners, circular, etc. The shape of this cross-section may furthermore vary along the opening.

The opening through the waveguide may further be provided with one or more ridges.

The cross section of the opening may be variable in area. For example, the opening may be flared in the case of a waveguide serving as an antenna.

The longitudinal axis of the opening through the waveguide device may be straight, as in the examples shown, or curved.

The opening through the waveguide may include a septum not shown to act as a polarizer to separate the two orthogonal polarities of a signal. The height of the septum may be variable, for example with stairsteps.

At least one end of the waveguide may include one or more flanges not shown to connect it to another waveguide device or equipment.

The waveguide is, for example, intended for use in a satellite to connect communications equipment, such as a radio frequency transmitter or receiver, to an antenna or antenna array. One end of the waveguide may be shaped as an antenna.

The shape and proportions of the section of this channel are determined according to the frequency of the electromagnetic signal to be transmitted or transformed.

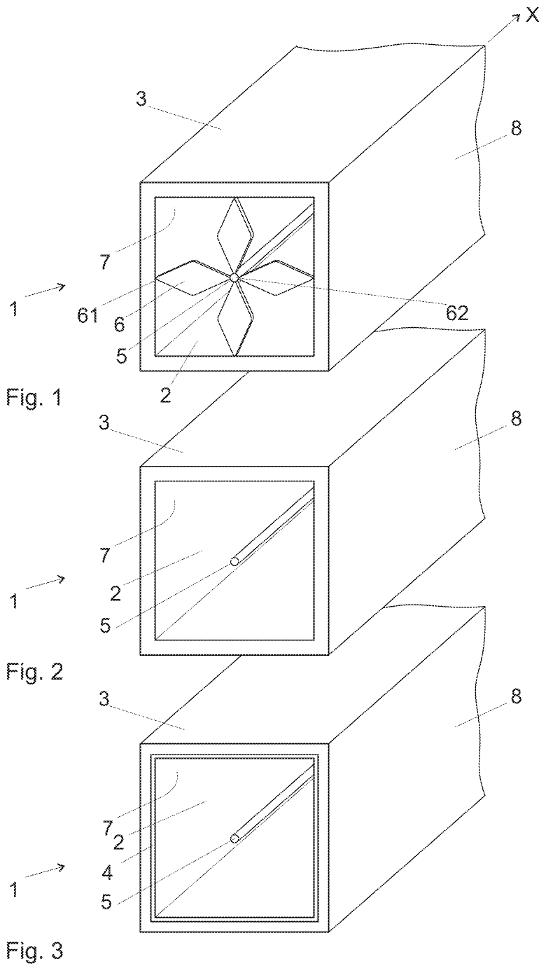

FIG. 1 illustrates an example of a semi-finished product 1 after the additive manufacturing operation, for example by stereolithography. It should be noted that this fabrication is preferably performed in successive layers parallel to the cross-section of the device, thus arranging the longitudinal x-axis vertically, so as to minimize the risk of sagging of cantilevered portions during printing. In the case of a device with a non-rectilinear longitudinal axis, the printing is preferably carried out in a direction that minimizes the problems of cantilevering during manufacture.

The opening 2 through the device 1 of FIG. 1 is provided with an electrically conductive anode 5 that is also made by additive manufacturing. This anode can be used for electrodeposition of layers on the walls of the opening and/or for electropolishing these walls.

The anode 5 is preferably made of the same material as the core 3 of the device, such as metal. In a preferred embodiment, the anode 3 is made with the same 3d printing machine and the same print head as the core 3, thus avoiding the need for several different 3d printing machines or machines with several heads for the core and the anode. However, it is possible to make the anode and the core in different materials or with separate printing heads or machines, especially when the core is made of an insulating material.

The anode is held in the opening 2 by means of portions 6, preferably detachable portions that connect points 62 on the anode to one or more points 61 on the walls of the opening 2, for example to one or more inner walls 7.

In one option, the detachable portions advantageously comprise pre-cut zones, for example zones of lesser thickness or diameter compared to the rest of the portions 6, and intended to be easily broken by manipulating the detachable portions with a hand, pliers or a cutting instrument.

In the illustrated example, the anode 5 is connected by four detachable portions 6 to four points 61 of the inner opening, which allows it to be positioned at a distance from the four walls, preferably equidistantly. In a preferred embodiment, different points 62 of the anode 5 at different distances along the anode 5 are connected by detachable portions to one or more walls 7 of the opening 2. This ensures that the anode 5 is precisely positioned in the opening 2 along its entire length. In one embodiment, each of the two ends of the opening 2 is connected to the anode 5 by one or more detachable portions 6; by placing them near the ends of the opening 2, detachment of the portions 6 is facilitated.

The detachable portions 6 are preferably made of the same electrically conductive material as the anode 5 and/or the core 3.

These detachable portions 6 are then detached by breaking the attachment points 61 to the walls 7 and/or the attachment points 62 to the anode, thereby galvanically isolating the anode 5 from the walls 7 of the opening 2 as illustrated in FIG. 2. The portions can be broken, for example, by exerting a twisting or pulling force directly on these portions, or by exerting a pulling force on the anode 5, which allows, for example, pre-cut areas to be broken.

The anode may be held after detachment of the portions 6 and during electrodeposition or electropolishing by temporary holding means not shown, such as a fixture or clamp at one or different ends of the device 1, etc.

In an embodiment, the walls of the core are then coated with a conductive layer, either by chemical deposition or by electrodeposition. After immersion, a current is then applied between the anode and this conductive layer operating as a cathode, in order to obtain an electropolishing of the conductive layer.

In another embodiment, the device 1 with the anode 5 is then immersed in a bath containing metal ions, and the inner surface 7 of the core 3 is coated by electrodeposition with a conductive metal layer 4, for example of copper, silver, gold, nickel etc., plated by chemical deposition with the application of an electric current through the anode and the walls 7 of the cathode opening. A conductive coating (not shown) serving as a cathode can be deposited on these walls beforehand, for example by electroless chemical deposition, especially when the core 3 is non-conductive. This coating can also serve as a smoothing layer.

The thickness of the layer 4 is for example between 1 and 20 micrometers, for example between 4 and 10 micrometers. The coating may also be an assembly of layers and comprise, for example, a smoothing layer directly on the core, one or more bonding layers, etc.

The thickness of the conductive coating 4 must be sufficient to ensure that the surface of the opening 2 is electrically conductive at the selected radio frequency. This is typically achieved with a conductive layer whose thickness is equal to or greater than the skin depth δ.

The external surface 8 of the channel is preferably also covered with a metal layer which, in particular, makes the device rigid and gives it the required strength.

In another embodiment, at least some of the detachable portions 6 are made in such a way as to avoid the creation of a galvanic bridge between the anode 5 and the cathode. For this purpose, the detachable portions may be made at least partially of an insulating material, or they may be attached to a portion of the core 3 that is itself insulating. In this embodiment, the detachable portions can be held during the electrodeposition step, and removed only after this step. This avoids the need to hold the anode with temporary holding means during electrodeposition.

What is claimed is:

1. A method for manufacturing a waveguide device comprising the following steps:
additive manufacturing of a core provided with an opening;
additive manufacturing of at least one portion of an anode through said opening; and
application of an electric current between said anode and a cathode, in order to carry out a deposition of a conductive metal layer on said core and/or an electropolishing of the walls of said opening,
wherein said anode is removed after electrodeposition or electropolishing.

2. The method of claim 1, wherein said deposition is carried out by immersing the core in a metal ion bath and then electrodepositing the conductive metal layer on the walls of said opening by applying electric current between said anode and cathode.

3. The method of claim 1, comprising a said electropolishing step by applying electric current between said anode and cathode.

4. The method of claim 1, wherein said core is formed of an electrically conductive material.

5. The method of claim 4, wherein said core and said anode are formed of the same metallic material and made in a single and same additive manufacturing step.

6. The method of claim 1, wherein said core is formed of an insulating material and coated with a conductive layer serving as said cathode during electrodeposition.

7. The method of claim 1, comprising the additive manufacturing of detachable portions for holding said anode in the opening at least during the manufacturing of the core.

8. The method of claim 7, wherein said detachable portions are detached prior to said electrodeposition step.

9. The method of claim 8, wherein said anode is held by temporary holding means after detachment of said detachable portions and during electrodeposition.

10. The method of claim 7, wherein said detachable portions are electrically insulated from the anode and/or from the cathode, or form an electrical insulation between the anode and the cathode, and are detached after said electrodeposition or electropolishing step.

11. Semi-finished product for the manufacture of a waveguide device, comprising:
a core provided with an opening;
an anode through said opening; and
detachable portions for temporarily holding the anode in the opening;
wherein said core, said anode and said detachable portions are all manufactured by additive manufacturing.

12. The product of claim 11, wherein said core is formed of an electrically conductive material.

13. The product of claim 12, wherein said core and said anode are formed of the same metallic material.

14. The product of claim 11, wherein said core is formed of an insulating material and coated with a conductive layer.

15. The product of claim 11, wherein said detachable portions include pre-cut areas.

16. The product of claim 11, wherein said detachable portions are electrically insulated from the anode and/or from the cathode, or form an electrical insulation between the anode and the cathode, and are configured to be detached after said electrodeposition or electropolishing step.
